(19) United States
(12) Patent Application Publication
(10) Pub. No.: US 2024/0359406 A1
(43) Pub. Date: Oct. 31, 2024

(54) METHOD FOR PRODUCING A PLASTIC COMPONENT

(71) Applicant: Frank Carsten HERZOG, Lichtenfels (DE)

(72) Inventor: Frank Carsten HERZOG, Lichtenfels (DE)

(21) Appl. No.: 18/682,705

(22) PCT Filed: Aug. 9, 2022
(86) PCT No.: PCT/EP2022/072328

§ 371 Date: Feb. 9, 2024

(30) Foreign Application Priority Data
Aug. 11, 2021 (DE) 10 2021 120 904.8

(51) Int. Cl. B29C 64/30; B29C 51/08; B29K 21/00; B29L 31/30; B33Y 40/00; B33Y 80/00

(52) U.S. Cl. CPC B29C 64/30; B29C 51/08; B33Y 40/00; B29K 2021/003; B29K 2995/0073; B29L 2031/30; B33Y 80/00

(57) ABSTRACT

The invention relates to a method for producing a plastic component (1) having defined target dimensions, in particular defined target outer dimensions, said method comprising: —forming a one- or multi-part base body structure (2) in an additive manufacturing process, wherein the base body structure (2) is formed with an undersize with respect to the defined geometric target dimensions, —attaching at least one enveloping element (3) enveloping the base body structure (2) on the exposed surfaces of the base body structure (2) by forming the plastic component (1) that is to be produced, wherein an enveloping element (3) is used, the wall thickness of which compensates the undersize of the base body structure (2) with respect to the defined geometric target dimensions of the plastic component (1).

The invention relates to a method for producing a plastic component of defined geometric target dimensions, in particular defined target outside dimensions.

Corresponding methods are known in principle from the prior art in a plurality of different embodiments for producing different types of plastic components.

It is known that plastic components can now be formed reliably via additive manufacturing processes, and therefore corresponding methods for producing plastic components can now also be implemented by means of additive manufacturing processes, in which the plastic components are typically constructed in an additive manner by successive layered selective hardening of construction materials.

Even if an almost infinite number of geometrically/structurally, and thus functionally, differently configured plastic components can be produced by additive manufacturing processes, and also in batch production, the characteristic properties for the additively formed plastic components, i.e. in particular surface properties, which allow for the layered construction to be inferred haptically and/or visually, may sometimes be undesired for certain applications.

There is therefore a need for a method for producing a plastic component that is improved in comparison therewith.

The object of the invention is therefore that of specifying a method, for producing a plastic component, which is improved in particular in view of the possibility of creating desired properties, i.e. in particular desired surface properties, such as in particular haptic and/or mechanical and/or optical surface properties.

The object is achieved by a method for producing a plastic component according to claim 1. The claims dependent thereon relate to possible embodiments of the method.

A first aspect of the invention relates to a method for producing a plastic component of defined geometric target dimensions, in particular defined target outside dimensions. The method therefore includes or comprises steps by means of which a plastic component of defined target dimensions, in particular defined target outside dimensions, can be produced.

A plastic component that can be or is produced according to the method can in general typically be understood to be a component which, as emerges in the following, comprises a main body structure which is formed of at least one plastics material or comprises at least one such material. The geometric/structural properties of a corresponding main body structure can be selected depending on the geometric/structural properties of the respective plastic component. A corresponding main body structure can, as emerges in the following, comprise one or more, in particular channel-like or channel-shaped, cavities. A corresponding main body structure can be formed integrally or in multiple parts.

A plastic component that can be or is produced according to the method can, in all embodiments, be a functional component, i.e. a component which fulfils at least one function in view of a specific application. A function can be e.g. a cover function, e.g. for covering a third object, a retaining function, e.g. for retaining a third object, a storage function, e.g. for storing a third object, a supply function, e.g. for supplying a third object with an energy carrier or a supply medium, or a temperature-control function, e.g. for controlling the temperature of a third object, etc.

A plastic component that can be or is produced according to the invention can be e.g. a vehicle component that is to be installed on or in a vehicle, in particular a motor vehicle, more particularly a passenger car. Therefore, according to the method in particular a plastic component in the form of a vehicle component, i.e. a component on or in a vehicle-which may in principle be a land vehicle, aircraft or watercraft, can be produced. Specifically, a corresponding vehicle component can for example be a trim component for the trim of a part of a vehicle exterior or interior.

In principle any component in which particular surface properties, i.e. in particular a particular surface structuring, are required or desirable, which do/does not make it possible to infer, haptically and/or visually, a layered construction in an additive manufacturing process, is possible as a plastic component that is to be or is produced according to the method.

The individual steps of the method are explained in greater detail in the following:

In a first step of the method, a corresponding main body structure is formed. The formation of the main body structure takes place in or includes a (first) additive manufacturing process, in which one or more plastics materials, i.e. in particular one or more thermoplastics materials, are processed for additively forming a three-dimensional object, i.e. in the present case the main body structure. The additive manufacturing process enables a layered construction of the main body structure. The main body structure can thus in principle be configured having almost infinite degrees of freedom with respect to its geometric/structural design.

As emerges in the following, for the additive formation of the main body structure, in particular extrusion-based additive manufacturing processes are possible in which plastics materials can be built up in an extrusion-based manner in the form of material or melt webs, via an extrusion unit comprising at least one extruder, continuously, quasi-continuously or discontinuously, in a layered manner, on a substrate, i.e. in particular on a construction panel or at least one previously applied material or melt web. In this case, a corresponding extrusion unit can be movable, relative to the respective substrate, via a suitable bearing means, in one or more degrees of freedom of movement.

In addition to the actual additive construction of the main body structure in a (first) additive manufacturing process, the formation of the main body structure in the first step can also include, e.g. mechanical and/or thermal, post-processing of a previously additively constructed main body structure, in at least one post-processing process.

According to the method, the main body structure is purposely formed having a definable or defined undersize with respect to the defined geometric target dimensions of the plastic component to be produced. Thus, in the first step of the method, a main body structure is formed in an additive manufacturing process, i.e. in particular by a successive layered formation of cross sections of the main body structure, and/or in an, e.g. mechanical and/or thermal, post-processing process, which main body structure purposely does not (yet) have the defined target dimensions of the plastic component to be produced, but rather a certain undersize. The term “undersize” thus also takes into account the dimensions of the main body structure after performing any post-processing processes, such as mechanical and/or thermal post-processing processes, by which the dimensions of the previously additively formed main body structure are reduced, e.g. by thermal and/or mechanical processes, to an undersize with respect to the defined geometric target dimensions of the plastic component to be produced. The term “additive manufacturing process” can thus also include at least one post-processing process, in addition to the actual additive manufacturing process. The main body structure present after the first step thus has an undersize with respect to the defined geometric target dimensions of the plastic component to be produced, which undersize results from the (first) additive manufacturing process and/or a post-processing process.

The main body structure is thus formed to be near net shape, on account of the undersize. The dataset describing the main body structure and underlying the respective additive manufacturing process thus does not describe the plastic component to be produced according to the invention, or the target dimensions of said component, but rather, in the form of the main body structure, a plastic component that typically resembles said plastic component to be produced in geometric/structural terms, but, put simply, is smaller on account of the defined undersize with respect to the defined geometric target dimensions of the plastic component to be produced.

Depending on the specific target dimensions of the plastic component to be produced, a respective undersize of the main body structure can mean a deviation of one or more percent from the target dimensions. This can mean, specifically, that, depending on the specific target dimensions of the plastic component to be produced, a corresponding undersize of the main body structure can mean a deviation of one or more micrometers, millimeters, or possibly even centimeters. Therefore, a main body structure can, for the simple example of a cuboid, have a length and/or width and or height that is a few micrometers, millimeters, or possibly even centimeters smaller than the plastic component. Similar of course applies for any other geometry of a main body structure or a plastic component.

It is conceivable that the main body structure is formed having a corresponding undersize only in regions. Thus, the main body structure can comprise one or more first regions which are formed having a defined undersize with respect to the defined geometric target dimensions of the plastic component to be produced, and thus do not exhibit the target dimensions of the respective plastic component, and can comprise one or more second regions which are not formed having a defined undersize with respect to the defined geometric target dimensions of the plastic component to be produced, and exhibit the target dimensions of the respective plastic component.

In a second step of the method, at least one shell element, which encases the main body structure at least in portions, optionally completely, is attached to the exposed surfaces of the main body structure, forming the plastic component to be produced. The at least one shell element is in particular attached to or on the regions of the main body structure which were previously formed having a corresponding undersize. Therefore, the at least one shell element is in particular attached to corresponding first regions which are or were formed having an undersize with respect to the defined geometric target dimensions of the plastic component to be produced.

According to the method, in this case a shell element is used, the wall thickness of which counteracts, and thus compensates, the undersize of the main body structure with respect to the defined geometric target dimensions of the plastic component to be produced. According to the method, the thickness or wall thickness of the shell element used in each case is therefore purposely selected in such a way that the delta resulting from the undersize, or the difference, resulting from the undersize, between the dimensions of the main body structure with respect to the defined target dimensions of the plastic component to be produced, is counteracted or compensated by attaching the at least one shell element. Therefore, the defined target dimensions of the plastic component are achieved by attaching the at least one shell element onto the main body structure; the plastic component is therefore produced, having the defined target outside dimensions, only by attachment of the shell element to the main body structure.

Analogous is conceivable in the case of a plurality of shell elements-therefore, the thickness or wall thickness of a plurality of shell elements can be purposely matched to one another or selected in such a way that the delta resulting from the undersize of the dimensions of the main body structure with respect to the defined target dimensions of the plastic component to be produced is counteracted or compensated by attaching a plurality of shell elements to the main body structure, in particular in layers.

It should also be noted that the main body structure can be formed, in portions, having different under sizes relative to the target dimensions of the respective plastic component, such that shell elements that are different in portions, and/or a different number of shell elements, can be provided, in order to counteract or to compensate the delta, resulting from the respective undersize, of the dimensions of the main body structure with respect to the defined target dimensions of the plastic component to be produced, by attaching one or more shell elements.

The surface properties of the plastic component produced according to the method are therefore defined at least in portions, optionally completely, by the surface properties of the at least one shell element. This firstly gives a reliable possibility for preventing any inference of the additive manufacture of the main body structure, since the main body structure is encased, at least in portions, optionally completely, by the at least one shell element, such that a layer structure resulting from the additive manufacturing process of the main body structure is no longer perceptible, in particular haptically and/or mechanically and/or visually. Furthermore, a possibility is provided of providing the plastic component with certain surface properties, in a targeted manner and in particular irrespective of the surface properties of the main body structure. Depending on the specific design of the at least one shell element, the plastic component can be provided for example with particular acoustic, electrical, haptic, mechanical, visual or thermal surface properties. Furthermore, the plastic component can be provided with particular structural properties, i.e. in particular mechanical properties, such as a particular strength.

In the same way, particular functionalities can be integrated into the plastic component. For example, electrically and/or thermally conductive structures, such as conducting tracks, can be integrated into the plastic component. Corresponding conductive structures can be arranged or formed e.g. in the main body structure and/or in the at least one shell element. Alternatively or in addition, corresponding conductive structures can be arranged or formed between the main body structure and the at least one shell element. For this purpose, the main body structure and/or the at least one shell element can optionally be provided with suitable, e.g. groove-like, receptacles, which enable a stable arrangement of corresponding conductive structures. Analogous applies for differently functionalized structures, such as data communications structures, armoring structures, reinforcing structures, etc. Analogous furthermore applies for other functional elements, such as coding elements, communications elements, e.g. RFID elements, sensor elements, etc., which can likewise be integrated into the plastic component in a corresponding manner.

The method accordingly typically provides two separate steps—a first step, in which the main body structure is formed having a certain undersize, and a second step, in which the undersize of the main body structure is counteracted or compensated by attaching at least one shell element, forming the plastic component.

Thus, overall, an improved method for producing a plastic component is provided.

The main body structure can, as mentioned, be formed additively from a plastics material, i.e. in particular a thermoplastic. Thus, for forming the main body structure a material group is possible which stands out from other material groups both in technical aspects, i.e. in particular also aspects of manufacturing technology, and in economic aspects. Merely by way of example, and therefore not exhaustively, reference is made to polyolefin-based plastics materials, such as polyethylene, polypropylene, or non-polyolefin-based plastics materials, such as acrylonitrile-butadiene-styrene copolymers, polyamides, polycarbonates, polyether ether ketones, polyether imides, polyimides, polystyrenes, etc., which can be used for additively forming the main body structure. Recycled plastics materials are also possible at least in part, optionally completely. In all cases, the term “plastics material” also includes mixtures of plastics materials which are similar or different in one chemical and/or physical material parameter. Likewise, the term “plastics material” also includes plastics materials filled with one or more e.g. fiber-like and/or particulate filler materials.

According to the method, at least one shell element can be used, which has a planar geometric shape. The at least one shell element typically has a particular shaping or deformation capacity, in order to be able to be applied to the respective regions of the main body structure as far as possible over the entire surface. The shaping or deformation capacity of the at least one shell element can optionally be promoted by temperature control, i.e. in particular heating, of the at least one shell element.

Specifically, according to the method, e.g. a shell element in the form of a film, sheet, or coating material can therefore be used. Thus, according to the method, a shell element in the form of a film, sheet, or coating material can be attached to the main body structure. Corresponding film, sheet, or coating materials can likewise be plastics materials. Similarly, for example metals or metal alloys are conceivable-therefore, the at least one shell element can be a film, sheet or coating made of a plastics material or a metal or metal alloy, i.e. for example a precious or light metal, or a precious metal or light metal alloy. A coating material can be formed by a coating that is applied to the main body structure in the manner or form of a paint, e.g. by spreading on, spraying on, or dipping.

At this point, it should be generally noted, again, that, according to the method, at least one shell element can be used, which is formed of a different material, i.e. optionally also of a different material group, from the main body structure. In the event of a chemical or physical incompatibility between the at least one shell element and the main body structure, which makes more difficult or prevents attachment of the at least one shell element to or on the main body structure, at least one adhesion agent, e.g. in the form of a glue, can be used, which enables attachment—this is to be understood in general to mean a stable, i.e. in particular non-detachable, fastening of the at least one shell element to or on the main body structure—of the at least one shell element to or on the main body structure.

In an analogous manner, prior to the attachment of the at least one shell element the main body structure can be provided with a functional layer for counteracting or compensating unevenness, resulting for example from the additive manufacturing process of the main body structure. A corresponding functional layer can accordingly counteract or compensate for example a “step effect” resulting from the additive manufacturing process of the main body structure, and thus a surface of the main body structure that is stepped at least in portions. A corresponding functional layer can optionally, in particular simultaneously, be applied to the main body structure when additively forming the main body structure in an additive manufacturing process. This can be achieved e.g. via a separate print head of an additive manufacturing device for forming the main body structure, via which head a functional material forming the functional layer—in this case this may be e.g. a comparatively low-viscosity or flexible plastics material—can be applied to the main body structure.

As mentioned above, attachment of the at least one shell element to or on the main body structure is to be understood in general to mean a stable, i.e. in particular non-detachable, fastening of the at least one shell element to or on the main body structure. Therefore, the attachment of the at least one shell element to or on the main body structure can in principle be achieved by any form-fitting and/or force-fitting and/or integral attachment process, optionally assisted by chemical and/or physical measures, which enables a stable, i.e. in particular non-detachable, fastening of the at least one shell element to or on the main body structure.

A specific example for an attachment process is a separate additive manufacturing process. Therefore, the at least one shell element can be attached to or on the main body structure in a separate additive manufacturing process. A separate additive manufacturing process is typically to be understood to be a separate, and thus independent, additive manufacturing process downstream of the additive manufacturing process used for forming the main body structure, in which separate process only the at least one shell element is formed—this can differ from the (first) additive manufacturing process used for forming the main body structure in at least one material and/or process parameter.

A further specific example for an attachment process is a deep-drawing process, in particular a vacuum forming process, more particularly a thermoforming process. Therefore, the at least one shell element—this applies in particular for film-like or sheet-like shell elements—can be attached onto the main body structure by means of a deep-drawing process, in particular a vacuum forming process, more particularly a thermoforming process. Within the context of the, optionally thermally assisted, deep-drawing process, the at least one shell element is applied onto the respective regions of the main body structure and fastened there, in particular integrally, i.e. in particular by adhesive bonding or welding. This can be associated with shaping or deformation of the at least one shell element. This is a process that is very easy to reproduce in terms of manufacturing technology, and by means of which high-quality plastic components can be reliably produced.

The main body structure can be formed at least in portions having a flow channel structure through which a flow medium, e.g. a gas, generated by a negative pressure on the exposed surface of the main body structure, can flow. A corresponding flow channel structure can comprise one or more flow channels which pass through the main body structure in one or more spatial planes and/or directions and which lead at least at one end into an opening of the surface of the main body structure. In this way, the main body structure can already be prepared for a corresponding deep-drawing process, i.e. in particular for a corresponding vacuum forming process, in which the at least one shell element is attached to or on the main body structure by means of application of a negative pressure or vacuum. The formation or integration of a corresponding flow channel structure in the main body structure is possible without problem, in a plurality of different variants, owing to the additive construction of the main body structure. The term “flow channel structure” also includes a porous structure, through which similarly a flow medium generated by a negative pressure on the exposed surface of the main body structure can flow.

It is the case for all embodiments that a corresponding attachment process can also include a shaping of the at least one shell element and/or the main body structure. The at least one shell element and/or the main body structure can accordingly optionally undergo a certain change in shape in the context of a corresponding attachment process; the change in shape of course typically takes place with respect to a desired shape of the plastic component that is to be produced.

In order to take account of the topic, indicated above, of a desired adhesion of the at least one shell element to or on the main body structure, the main body structure can be formed at least in part, optionally completely, having a surface structuring which promotes adhesion of the at least one shell element, in particular a surface roughness which promotes adhesion of the at least one shell element. The formation or integration of a corresponding surface structure in the main body structure is possible without problem, in a plurality of different variants, owing to the additive construction of the main body structure.

A corresponding surface structuring of the main body structure, formed e.g. by elevations and/or depressions, or comprising such, can be configured analogously to the functional layer mentioned above. Therefore, prior to the attachment of the at least one shell element the main body structure can be provided with a surface structuring for promoting the adhesion of the at least one shell element. A corresponding surface structuring can optionally, in particular simultaneously, be applied to the main body structure when additively forming the main body structure in an additive manufacturing process. This can be achieved e.g. via a separate print head of an additive manufacturing device for forming the main body structure, via which head a construction material forming the surface structuring—in this case this may be e.g. a material that is very compatible with the at least one shell element—can be applied to the main body structure.

Returning to the additive manufacturing process used for additive formation of the main body structure, it is again noted that the main body structure, as mentioned, can be formed in particular in an extrusion-based additive manufacturing process. Extrusion-based additive manufacturing processes are distinguished from other additive manufacturing process, i.e. in particular powder bed-based additive manufacturing processes, in particular by reduced construction times, and the plastics materials that can be used. Specifically, in a corresponding extrusion-based additive manufacturing process, thermoplastics can be processed, which are also processed in conventional plastics processing processes, i.e. in particular extrusion or injection molding processes. Therefore, in particular thermoplastics can be processed in a corresponding extrusion-based additive manufacturing process which, for example in contrast to filament materials originally provided exclusively or especially for additive manufacturing processes, are originally not provided exclusively or especially for additive manufacturing processes.

In a corresponding manner, in a corresponding extrusion-based additive manufacturing process, plastics materials, i.e. in particular what are known as original materials, can be used for forming the main body structure which are also processed in conventional plastics processing processes, i.e. in particular extrusion or injection molding processes, but cannot be readily processed using other additive manufacturing processes. In particular, in a corresponding extrusion-based additive manufacturing process, plastics materials that are referred to as granule-like, i.e. are provided or present as granules, can be used for forming the main body structure which are also processed in conventional plastics processing processes, i.e. in particular extrusion or injection molding processes.

Correspondingly, the main body structure can be formed in an extrusion-based additive manufacturing process from a granule-like starting plastics material. Merely by way of example, reference is made in this connection to additive manufacturing processes by means of which thermoplastic injection molding granules, optionally filled with one or more filler materials, can be processed. Said additive manufacturing processes are accordingly suitable in particular for forming the main body structure.

A second aspect of the invention relates to a plastic component which was produced according to a method according to the first aspect of the invention. All that is stated in connection with the first aspect of the invention applies analogously for the second aspect of the invention, and vice versa.

The invention is explained again in the following with reference to the drawings, in which:

FIG. 1 is a flow diagram for illustrating the steps of a method for producing a plastic component according to an embodiment; and

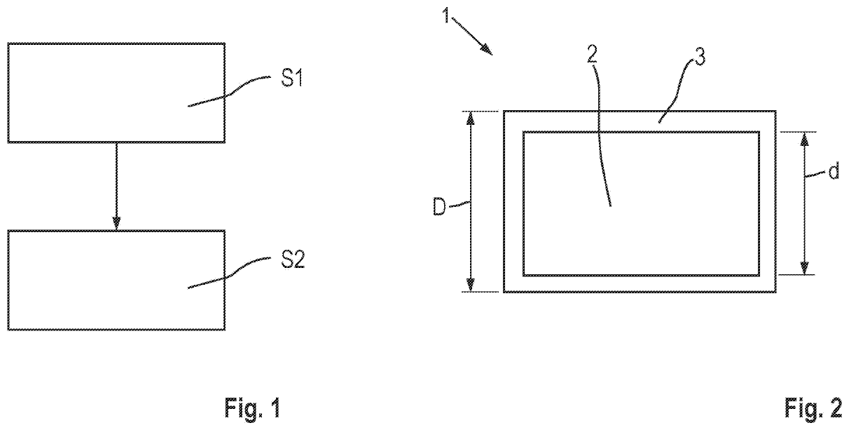

FIGS. 2-4 are each sectional views of a plastic component according to an embodiment.

FIG. 1 is a flow diagram for illustrating the steps of a method for producing a plastic component 1 according to an embodiment.

The method serves for producing a plastic component 1 of defined geometric target dimensions, in particular defined target outside dimensions, and therefore includes or comprises steps by means of which a plastic component 1 of defined target dimensions, in particular defined target outside dimensions, can be produced.

A plastic component 1 that can be or is produced according to the method can in general typically be understood to be a component which, as emerges in the following, comprises a main body structure 2 which is formed of at least one plastics material or comprises at least one such material. The geometric/structural properties of a corresponding main body structure 2 can in principle be selected depending on the geometric/structural properties of the respective plastic component 1.

A plastic component 1 that can be or is produced according to the method can, in all embodiments, be a functional component, i.e. a component which fulfils at least one function in view of a specific application. A function can be e.g. a cover function, e.g. for covering a third object, a retaining function, e.g. for retaining a third object, a storage function, e.g. for storing a third object, a supply function, e.g. for supplying a third object with an energy carrier or a supply medium, or a temperature-control function, e.g. for controlling the temperature of a third object, etc.

A plastic component 1 that can be or is produced according to the invention can be e.g. a vehicle component that is to be installed on or in a vehicle, in particular a motor vehicle, more particularly a passenger car. Specifically, a corresponding vehicle component can for example be a trim component for the trim of a part of a vehicle exterior or interior.

In principle any component in which particular surface properties, i.e. in particular a particular surface structuring, are required or desirable, which do/does not make it possible to infer, haptically and/or visually, a layered construction in an additive manufacturing process, is possible as a plastic component 1 that is to be or is produced according to the method.

The individual steps of the method are explained in greater detail in the following, with reference to FIG. 1:

In a first step S1 of the method, an additive formation of a corresponding main body structure 2 takes place in a (first) additive manufacturing process, in which one or more plastics materials, i.e. in particular one or more thermoplastics materials, are processed for additively forming the main body structure 2. The main body structure 2 can thus in principle be configured having almost infinite degrees of freedom with respect to its geometric/structural design.

As emerges in the following, for the additive formation of the main body structure, in particular extrusion-based additive manufacturing processes are possible in which plastics materials can be built up in an extrusion-based manner in the form of material or melt webs, via an extrusion unit comprising at least one extruder, continuously, quasi-continuously or discontinuously, in a layered manner, on a substrate, i.e. in particular on a construction panel or at least one previously applied material or melt web. In this case, a corresponding extrusion unit can be movable, relative to the respective substrate, via a suitable bearing means, in one or more degrees of freedom of movement.

In addition to the actual additive construction of the main body structure 2 in a (first) additive manufacturing process, the formation of the main body structure 2 in the first step S1 can also include, e.g. mechanical and/or thermal, post-processing of a previously additively constructed main body structure, in at least one post-processing process.

According to the method, the main body structure 2 is purposely formed having a definable or defined undersize with respect to the defined geometric target dimensions of the plastic component 1 to be produced. Thus, in the first step S1 of the method, a main body structure 2 is formed in an additive manufacturing process, i.e. in particular by a successive layered formation of cross sections of the main body structure 2, and/or in an, e.g. mechanical and/or thermal, post-processing process, which main body structure purposely does not (yet) have the defined target dimensions of the plastic component 1 to be produced, but rather a certain undersize.

The term “undersize” thus also takes into account the dimensions of the main body structure 2 after performing any post-processing processes, such as mechanical and/or thermal post-processing processes, by which the dimensions of the additively formed main body structure 2 are reduced, e.g. by thermal and/or mechanical processes, to an undersize with respect to the defined geometric target dimensions of the plastic component 1 to be produced. The main body structure 2 present after the first step S1 thus has an undersize with respect to the defined geometric target dimensions of the plastic component 1 to be produced, which undersize results from the (first) additive manufacturing process and/or a post-processing process.

The undersize is indicated in FIG. 2 purely schematically by the reduced dimensions d of the main body structure 2 compared with the target dimensions D of the plastic component 1. The main body structure 2 is thus formed to be near net shape, on account of the undersize. The dataset describing the main body structure 2 and underlying the respective additive manufacturing process thus does not describe the plastic component 1 to be produced according to the invention, or the target dimensions of said component, but rather, in the form of the main body structure 2, a plastic component that typically resembles said plastic component to be produced in geometric/structural terms, but is smaller on account of the defined undersize with respect to the defined geometric target dimensions of the plastic component 1 to be produced.

Depending on the specific target dimensions of the plastic component 1 to be produced, the undersize of the main body structure 2 can mean a deviation of one or more percent from the target dimensions. This can mean, specifically, that, depending on the specific target dimensions of the plastic component 1 to be produced, a corresponding undersize of the main body structure 2 can mean a deviation of one or more micrometers, millimeters, or possibly even centimeters. Therefore, the main body structure 2 can, for the simple example of a cuboid, have a length and/or width and or height that is a few micrometers, millimeters, or possibly even centimeters smaller than the plastic component 1. Similar of course applies for any other geometry of the main body structure 2 or of the plastic component 1.

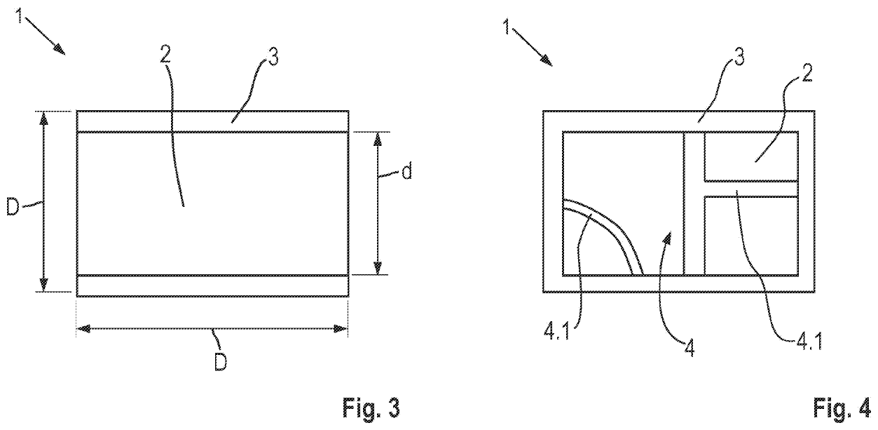

It is conceivable that the main body structure 2—as indicated by way of example in the embodiment according to FIG. 3—is formed having a corresponding undersize only in regions. Thus, the main body structure 2 can comprise one or more first regions which are formed having a defined undersize with respect to the defined geometric target dimensions of the plastic component 1 to be produced, and thus do not exhibit the target dimensions of the respective plastic component 1, and can comprise one or more second regions which are not formed having a defined undersize with respect to the defined geometric target dimensions of the plastic component 1 to be produced, and exhibit the target dimensions of the respective plastic component 1.

In a second step S2 of the method, at least one shell element 3, which encases the main body structure 2 at least in portions, optionally completely, is attached to the exposed surfaces of the main body structure 1, forming the plastic component 1 to be produced. The at least one shell element 3 is in particular attached to or on the regions of the main body structure 2 which were previously formed having a corresponding undersize. Therefore, the at least one shell element 3 is in particular attached to corresponding first regions which are or were formed having an undersize with respect to the defined geometric target dimensions of the plastic component 1 to be produced.

According to the method, in this case—as is visible on the basis of FIGS. 2-4—a shell element 3 is used, the wall thickness of which counteracts, and thus compensates, the undersize of the main body structure 2 with respect to the defined geometric target dimensions of the plastic component 1 to be produced. According to the method, the thickness or wall thickness of the shell element 3 used in each case is therefore purposely selected in such a way that the delta resulting from the undersize, or the difference, resulting from the undersize, between the dimensions of the main body structure 2 with respect to the defined target dimensions of the plastic component 1 to be produced, is counteracted or compensated by attaching the at least one shell element 3. Therefore, the defined target dimensions of the plastic component 1 are achieved by attaching the at least one shell element 3 onto the main body structure 2; the plastic component 1 is therefore produced, having the defined target outside dimensions, only by attachment of the shell element 3 to the main body structure 2.

Analogous is conceivable in the case of a plurality of shell elements 3—therefore, the thickness or wall thickness of a plurality of shell elements 3 can be purposely matched to one another or selected in such a way that the delta resulting from the undersize of the dimensions of the main body structure 2 with respect to the defined target dimensions of the plastic component 1 to be produced is counteracted or compensated by attaching a plurality of shell elements 3 to the main body structure 2, in particular in layers.

It should also be noted that the main body structure 2 can be formed, in portions, having different under sizes relative to the target dimensions of the respective plastic component 1, such that shell elements 3 that are different in portions, and/or a different number of shell elements 3, can be provided, in order to counteract or to compensate the delta, resulting from the respective undersize, of the dimensions of the main body structure 2 with respect to the defined target dimensions of the plastic component 1 to be produced, by attaching one or more shell elements 3.

The surface properties of the plastic component 1 produced are therefore defined at least in portions, optionally completely, by the surface properties of the shell element 3. This firstly gives a reliable possibility for preventing any inference of the additive manufacture of the main body structure 2, since the main body structure 2 is encased, at least in portions, optionally completely, by the shell element 3, such that a layer structure resulting from the additive manufacturing process of the main body structure 2 is no longer perceptible, in particular haptically and/or mechanically and/or visually. Furthermore, a possibility is provided of providing the plastic component 1 with certain surface properties, in a targeted manner and in particular irrespective of the surface properties of the main body structure 2. Depending on the specific design of the shell element 3, the plastic component 1 can be provided for example with particular acoustic, electrical, haptic, visual or thermal surface properties.

Furthermore, the plastic component 1 can be provided with particular structural properties, i.e. in particular mechanical properties, such as a particular strength.

In the same way, particular functionalities can be integrated into the plastic component 1. For example, electrically and/or thermally conductive structures, such as conducting tracks, can be integrated into the plastic component 1. Corresponding conductive structures can be arranged or formed e.g. in the main body structure 2 and/or in the shell element 3. Alternatively or in addition, corresponding conductive structures can be arranged or formed between the main body structure 2 and the at least one shell element 3. For this purpose, the main body structure 2 and/or the shell element 3 can optionally be provided with suitable, e.g. groove-like, receptacles (not shown), which enable a stable arrangement of corresponding conductive structures. Analogous applies for differently functionalized structures, such as data communications structures, armoring structures, reinforcing structures, etc. Analogous furthermore applies for other functional elements, such as coding elements, communications elements, e.g. RFID elements, sensor elements, etc., which can likewise be integrated into the plastic component 1 in a corresponding manner.

The method accordingly typically provides two separate steps—a first step S1, in which the main body structure 2 is formed having a certain undersize, and a second step, in which the undersize of the main body structure 2 is counteracted or compensated by attaching at least one shell element 3, forming the plastic component 1.

The main body structure 2 can, as mentioned, be formed additively from a plastics material, i.e. in particular a thermoplastic. Merely by way of example, and therefore not exhaustively, reference is made to polyolefin-based plastics materials, such as polyethylene, polypropylene, or non-polyolefin-based plastics materials, such as acrylonitrile-butadiene-styrene copolymers, polyamides, polycarbonates, polyether ether ketones, polyether imides, polyimides, polystyrenes, etc., which can be used for additively forming the main body structure 2. Recycled plastics materials are also possible at least in part, optionally completely. In all cases, the term “plastics material” also includes mixtures of plastics materials which are similar or different in one chemical and/or physical material parameter. Likewise, the term “plastics material” also includes plastics materials filled with one or more e.g. fiber-like and/or particulate filler materials.

According to the method, a shell element 3 can be used, which has a planar geometric shape. The shell element 3 typically has a particular shaping or deformation capacity, in order to be able to be applied to the respective regions of the main body structure 2 as far as possible over the entire surface. The shaping or deformation capacity of the shell element 3 can optionally be promoted by temperature control, i.e. in particular heating, of the shell element 3.

Specifically, according to the method, e.g. a shell element 3 in the form of a film, sheet, or coating material can therefore be used, and thus attached to the main body structure 2. Corresponding film, sheet, or coating materials can likewise be plastics materials. Similarly, for example metals or metal alloys are conceivable-therefore, the shell element 3 can be a film, sheet or coating made of a plastics material or a metal or metal alloy, i.e. for example a precious or light metal, or a precious metal or light metal alloy. A coating material can be formed by a coating that is applied to the main body structure 2 in the manner or form of a paint, e.g. by spreading on, spraying on, or dipping.

In the event of a chemical or physical incompatibility between the shell element 3 and the main body structure 2, which makes more difficult or prevents attachment of the shell element 3 to or on the main body structure 2, at least one adhesion agent, e.g. in the form of a glue, can be used, which enables attachment—this is to be understood in general to mean a stable, i.e. in particular non-detachable, fastening of the shell element 3 to or on the main body structure 2—of the shell element 3 to or on the main body structure 2.

In an analogous manner, prior to the attachment of the shell element 3 the main body structure 2 can be provided with a functional layer (not shown) for counteracting or compensating unevenness, resulting for example from the additive manufacturing process of the main body structure 2. A corresponding functional layer can accordingly counteract or compensate for example a “step effect” resulting from the additive manufacturing process of the main body structure 2, and thus a surface of the main body structure 2 that is stepped at least in portions. A corresponding functional layer can optionally, in particular simultaneously, be applied to the main body structure 2 when additively forming the main body structure 2 in an additive manufacturing process. This can be achieved e.g. via a separate print head of an additive manufacturing device for forming the main body structure 2, via which head a functional material forming the functional layer—in this case this may be e.g. a comparatively low-viscosity or flexible plastics material—can be applied to the main body structure 2.

As mentioned above, attachment of the shell element 3 to or on the main body structure 2 is to be understood in general to mean a stable, i.e. in particular non-detachable, fastening of the shell element 3 to or on the main body structure 2. Therefore, the attachment of the shell element 3 to or on the main body structure 2 can in principle be achieved by any form-fitting and/or force-fitting and/or integral attachment process, optionally assisted by chemical and/or physical measures, which enables a stable, i.e. in particular non-detachable, fastening of the shell element 3 to or on the main body structure 2.

A specific example for an attachment process is a separate additive manufacturing process. Therefore, the shell element 3 can be attached to or on the main body structure 2 in a separate additive manufacturing process. A separate additive manufacturing process is typically to be understood to be a separate, and thus independent, additive manufacturing process downstream of the additive manufacturing process used for forming the main body structure 2, in which separate process only the shell element 3 is formed—this can differ from the (first) additive manufacturing process used for forming the main body structure 2 in at least one material and/or process parameter.

A further specific example for an attachment process is a deep-drawing process, in particular a vacuum forming process, more particularly a thermoforming process. Therefore, the shell element 3—this applies in particular for film-like or sheet-like shell elements 3—can be attached onto the main body structure 2 by means of a deep-drawing process, in particular a vacuum forming process, more particularly a thermoforming process. Within the context of the, optionally thermally assisted, deep-drawing process, the shell element 3 is applied onto the respective regions of the main body structure 2 and fastened there, in particular integrally, i.e. in particular by adhesive bonding or welding. This is typically associated with shaping or deformation of the shell element 3.

The main body structure 2 can—as indicated schematically in the embodiment according to FIG. 4—be formed at least in portions having a flow channel structure 4 through which a flow medium, e.g. a gas, generated by a negative pressure on the exposed surface of the main body structure 2, can flow. The or a corresponding flow channel structure 4 can comprise one or more flow channels 4.1 which pass through the main body structure 2 in one or more spatial planes and/or directions and which lead at least at one end into an opening of the surface of the main body structure 2. In this way, the main body structure 2 can already be prepared for a corresponding deep-drawing process, i.e. in particular for a corresponding vacuum forming process, in which the shell element 3 is attached to or on the main body structure 2 by means of application of a negative pressure or vacuum. The formation or integration of a corresponding flow channel structure 4 in the main body structure 2 is possible without problem, in a plurality of different variants, owing to the additive construction of the main body structure 2. The term “flow channel structure” also includes a porous structure, through which similarly a flow medium generated by a negative pressure on the exposed surface of the main body structure 2 can flow.

It is the case for all embodiments that a corresponding attachment process can also include a shaping of the shell element 3 and/or of the main body structure 2. The shell element 3 and/or the main body structure 2 can accordingly optionally undergo a certain change in shape in the context of a corresponding attachment process; the change in shape of course typically takes place with respect to a desired shape of the plastic component 1 that is to be produced.

The main body structure 2 can be formed having a surface structuring (not shown) which promotes adhesion of the shell element 3, in particular a surface roughness which promotes adhesion of the shell element 3. The formation or integration of a corresponding surface structure in the main body structure 2 is possible without problem, in a plurality of different variants, owing to the additive construction of the main body structure 2.

A corresponding surface structuring of the main body structure 2, formed e.g. by elevations and/or depressions, or comprising such, can be configured analogously to the functional layer mentioned above. Therefore, prior to the attachment of the shell element 3 the main body structure 2 can be provided with a surface structuring for promoting the adhesion of the shell element 3. A corresponding surface structuring can optionally, in particular simultaneously, be applied to the main body structure 2 when additively forming the main body structure 2 in an additive manufacturing process. This can be achieved e.g. via a separate print head of an additive manufacturing device for forming the main body structure 2, via which head a construction material forming the surface structuring—in this case this may be e.g. a material that is very compatible with the shell element 3—can be applied to the main body structure 2.

Returning to the additive manufacturing process used for additive formation of the main body structure 2, it is again noted that the main body structure 2, as mentioned, can be formed in particular in an extrusion-based additive manufacturing process. Extrusion-based additive manufacturing processes are distinguished from other additive manufacturing process, i.e. in particular powder bed-based additive manufacturing processes, in particular by reduced construction times, and the plastics materials that can be used. Specifically, in a corresponding extrusion-based additive manufacturing process, thermoplastics can be processed, which are also processed in conventional plastics processing processes, i.e. in particular extrusion or injection molding processes. Therefore, in particular thermoplastics can be processed in a corresponding extrusion-based additive manufacturing process which are originally not provided exclusively or especially for additive manufacturing processes.

Therefore, in a corresponding extrusion-based additive manufacturing process, plastics materials, i.e. in particular what are known as original materials, can be used for forming the main body structure 2 which are also processed in conventional plastics processing processes, i.e. in particular extrusion or injection molding processes, but cannot be readily processed using other additive manufacturing processes. In particular, in a corresponding extrusion-based additive manufacturing process, plastics materials that are referred to as granule—like, i.e. are provided or present as granules, can be used for forming the main body structure 2 which are also processed in conventional plastics processing processes, i.e. in particular extrusion or injection molding processes.

Correspondingly, the main body structure 2 can be formed in an extrusion-based additive manufacturing process from a granule-like starting plastics material. Merely by way of example, reference is made in this connection to additive manufacturing processes by means of which thermoplastic injection molding granules, optionally filled with one or more filler materials, can be processed. Said additive manufacturing processes are accordingly suitable in particular for forming the main body structure 2.

Individual, a plurality of, or all of the features disclosed in connection with a first embodiment can be combined with individual, a plurality of, or all of the features disclosed in connection with at least one further embodiment.

1. A method for producing a plastic component of defined geometric target dimensions, comprising:
forming an integral or multi-part main body structure in an additive manufacturing process, wherein the main body structure is configured having an undersize with respect to the defined geometric target dimensions,
attaching at least one shell element, which encases the main body structure, onto the free surface of the main body structure, forming the plastic component to be produced,
wherein a shell element is used, the wall thickness of which counteracts the undersize of the main body structure with respect to the defined geometric target dimensions of the plastic component.

2. The method according to claim 1, wherein the main body structure is formed of a plastic material.

3. The method according to claim 1, wherein the at least one shell element is attached onto the main body structure in the form of a film, sheet, or a coating material.

4. The method according to claim 1, wherein the at least one shell element is attached onto the main body structure in a separate additive manufacturing process.

5. The method according to claim 1, wherein the at least one shell element is attached onto the main body structure in a deep-drawing process.

6. The method according to claim 1, wherein the main body structure is formed at least in portions having a flow channel structure through which a flow medium, generated by a negative pressure on the exposed surface of the main body structure, can flow.

7. The method according to claim 1, wherein at least one adhesion agent, which enables attachment of the at least one shell element to or onto the main body structure, is applied to the main body structure.

8. The method according to claim 1, wherein prior to the attachment of the at least one shell element the main body structure is provided with a functional layer for counteracting or compensating unevenness, resulting for example from the additive manufacturing process of the main body structure.

9. The method according to claim 1, wherein the main body structure is formed having a surface structuring which promotes adhesion of the at least one shell element.

10. The method according to claim 9, wherein the surface structuring is applied in an additive manufacturing process, on the main body structure.

11. The method according to claim 1, wherein the main body structure is formed in an extrusion-based additive manufacturing process.

12. The method according to claim 1, wherein the main body structure is formed in an additive manufacturing process from a granule-like starting plastic material.

13. The method according to claim 1, wherein a vehicle component to be installed in a vehicle is produced as the plastic component.

14. A plastic component which is produced according to the method according to claim 1.

15. The method according to claim 2, wherein the plastic material is a thermoplastic.

16. The method according to claim 5, wherein the at least one shell element is attached onto the main body structure in a vacuum forming process or in a thermoforming process.

17. The method according to claim 9, wherein the main body structure is formed having a surface structuring having a surface roughness which promotes adhesion of the at least one shell element.

18. The method according to claim 10, wherein the surface structuring is applied in an additive manufacturing process simultaneously with the formation of the main body structure on the main body structure.

19. The method according to claim 13, wherein a motor vehicle is produced as the plastic component.

20. The method according to claim 1, wherein the defined geometric target dimensions are defined target outside dimensions.
